(19) United States
(12) Patent Application Publication
(10) Pub. No.: US 2013/0295919 A1
(43) Pub. Date: Nov. 7, 2013

(54) INTELLIGENT CONTROL SOCKET SYSTEM

(71) Applicant: Jian Lin ZHOU, GUANGDONG PROVINCE (CN)

(72) Inventor: Jian Lin ZHOU, GUANGDONG PROVINCE (CN)

(73) Assignee: MIG TECHNOLOGY INC., GUANGDONG PROVINCE (CN)

(21) Appl. No.: 13/553,823

(22) Filed: Jul. 20, 2012

(30) Foreign Application Priority Data
May 7, 2012 (CN) 201220200042.6

(51) Int. Cl. H04W 88/06

(52) U.S. Cl. 455/426.1

(57) ABSTRACT

An intelligent control socket system, comprising a socket function module set and a ZigBee module set, a local network control host and a human-machine operating platform connected to the socket function module set in turn, wherein the socket function module set is in connection and communication with the ZigBee module set by USB; the ZigBee module set is in wireless connection and communication with the local network control host via ZigBee; and the local network control host is in connection and communication with the human-machine operating platform via WIFI and GPRS. The control system is integrated and modularized, including an intelligent socket with a USB communication function; a ZigBee-USB conversion module; a ZigBee, WIFI, GPRS communication protocol conversion module; a user terminal operation interface, supporting WIFI and GPRS communication.

### BACKGROUND OF THE INVENTION

The utility model relates to a socket, especially an intelligent control socket system.

The appearance and wiring mode of the intelligent socket is similar to those of the common socket. Except for the functions of the common socket, the intelligent socket can also acquire power consumption data, such as the current, voltage, electric quantity and active power, transmit data in a radio mode and store data.

The intelligent socket refers to a socket capable of being inserted by one or more than one circuit connection. Various connections can be connected with other circuits via the intelligent socket. Along with the enrichment and variation of the household appliances, the household sockets are developed in the direction of the extension sockets with many jacks. The existing extension socket functions to convert the mains supply into several ones, protects the electric device and even controls the functions of the electric device.

Many types of intelligent sockets with various functions are available on the market. The intelligent control technology is integrated in the traditional socket, which realizes safe control over the electric appliances and personal and financial protection, reduces waste of electric energies and facilitates users to control the electric appliances more, and meets higher and higher demands of the power and socket market on safety.

### BRIEF SUMMARY OF THE INVENTION

The objective of this utility model is to overcome the defects of the prior art and provide an intelligent control socket system. By combining the ZigBee and WIFI technologies and in a multifunctional control mode, the service conditions of the socket such as the current, voltage and power can be controlled better and the socket is used safely.

To fulfill the abovementioned aim, the utility model adopts the following technical scheme: an intelligent control socket system comprises a socket function module set and also comprises a ZigBee module set, a local network control host and a human-machine operating platform which are connected with the socket function module set in turn, wherein the socket function module set is in connection and communication with the ZigBee module set by USB; the ZigBee module set is in wireless connection and communication with the local network control host via ZigBee; and the local network control host is in connection and communication with the human-machine operating platform via WIFI and GPRS.

Furthermore, the socket function module set comprises a liquid crystal display module, a protection and power interruption module and an external communication port.

Furthermore, the liquid crystal display module comprises a current load display module, a power supply voltage display module, a consumption power display module and a total power consumption display module.

Furthermore, the protection and power interruption module comprise an over-current protection module, an over-voltage protection module and a high-temperature protection module.

Furthermore, the external communication port comprises a USB communication interface in connection and communication with an external load control device and a USB communication interface in connection and communication with the ZigBee module set.

Furthermore, the ZigBee module set is externally provided with a USB communication connector so as to be in uplink connection with the local network control host and in downlink connection with the socket function module set.

Furthermore, the ZigBee module set is in radio connection and communication with the local network control host via the ZigBee; and the ZigBee is the 802.15.4 protocol.

Furthermore, the local network control host is provided with a ZigBee and WIFI communication protocol conversion device, a ZigBee and GPRS communication protocol conversion device, and a liquid crystal display local network operating platform; and the local network control host is also provided with a serial port communication port, and WIFI wireless connection point and a GPRS wireless connection point.

Furthermore, the human-machine operating platform (4) comprises an android system, an IOS system and an IPAD control platform.

Compared with the prior art, the utility model has the following beneficial effects: by combining the perspective features of ZigBee and WIFI and by establishing a local network with the ZigBee technology (802.15.4), the WIFI (802.11x) technology and the GPRS technology allow a cell phone to realize remote linking; the system has three kinds of control modes: 1, the cell phone realizes control via the WIFI AD-HOC local network; 2, the cell phone realizes remote control in the WIFI+AP mode via the internet; 3, the cell phone realizes remote control via GPRS, wherein the user terminal platform includes the Android system, two types of IOS cell phone platforms and the IPAD control platform; by combining the ZigBee and WIFI technologies and in a multifunctional control mode, the service conditions of the socket such as the current, voltage and power can be controlled better and the socket is used safely. In this utility model, the control system is integrated and modularized, including an intelligent socket with a USB communication function; a ZigBee-USB conversion module; a ZigBee, WIFI, GPRS communication protocol conversion module; a user terminal operation interface, supporting WIFI and GPRS communication.

### BRIEF DESCRIPTION OF THE DRAWINGS

FIG. 1 is a functional block diagram of the utility model.

### DETAILED DESCRIPTION OF THE INVENTION

The utility model is further described in details with the reference of the embodiments and attached drawing so as to better explain the technical features and advantages of the utility model.

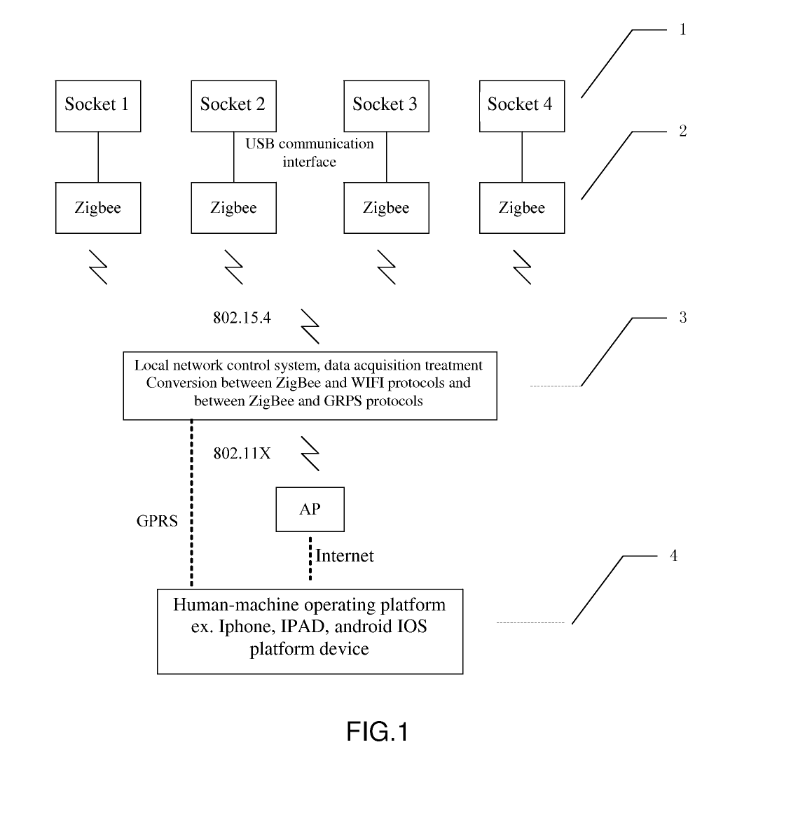

FIG. 1 illustrates the functional block diagram of the utility model. An intelligent control socket system comprises a socket function module set 1 and also comprises a ZigBee module set 2, a local network control host 3 and a human-machine operating platform 4 which are connected with the socket function module set 1 in turn, wherein the socket function module set 1 is in connection and communication with the ZigBee module set 2 by USB; the ZigBee module set 2 is in wireless connection and communication with the local network control host 3 via ZigBee; and the local network control host 3 is in connection and communication with the human-machine operating platform 4 via WIFI and GPRS.

Furthermore, the socket function module set 1 comprises a liquid crystal display module, a protection and power interruption module and an external communication port.

Furthermore, the liquid crystal display module comprises a load current display module, a power supply voltage display module, a consumption power display module and a total power consumption display module.

Furthermore, the protection and power interruption module comprises an over-current protection module, an over-voltage protection module and a high-temperature protection module.

Furthermore, the external communication port comprises a USB communication interface in connection and communication with an external load control device and a USB communication interface in connection and communication with the ZigBee module set 2.

Furthermore, the ZigBee module set 2 is externally provided with a USB communication connector so as to be in uplink connection with the local network control host 3 and in downlink connection with the socket function module set 1.

Furthermore, the ZigBee module set 2 is in radio connection and communication with the local network control host 3 via the ZigBee; the ZigBee is the 802.15.4 protocol.

Furthermore, the local network control host 3 is provided with a ZigBee and WIFI communication protocol conversion device, a ZigBee and GPRS communication protocol conversion device, and a liquid crystal display local network operating platform; and the local network control host 3 is also provided with a serial port communication port, and WIFI wireless connection point and a GPRS wireless connection point.

Furthermore, the human-machine operating platform 4 comprises an android system, an IOS system and an IPAD control platform.

The socket function module set 1 has a liquid crystal display module which displays the load current, power supply voltage, consumption power and a total power consumption, a protection and interruption function which includes over-current protection, over-voltage protection and high-temperature protection, an external communication port which includes a USB communication interface in communication with an external control device and a USB interface in communication with a ZigBee module to realize ZigBee wireless control and data acquisition.

The ZigBee module set 2 has a realization function, realizing wireless uplink connection with the controller at the main station and downlink USB connection with the controlled socket to forward data and commands, relay communication among devices and enlarge the communication scope under control; and ZigBee module set 2 is provided with an external interface for the USB communication connector.

The local network control host 3 has two communication modes: downlink communication between 802.15.4 Zigbee and zegbee module and uplink WIFI 802.11x protocol communication in connection with WIFI; a realizing function, realizing communication protocol conversion between ZigBee and WIFI, communication protocol conversion between ZigBee and GPRS; and a liquid crystal display local network operating interface which is a human-machine operating interface capable of manually controlling and setting the device of the ZigBee local network via the local network control platform, and a device interface including a serial-port communication port, a WIFI wireless connection point and a GPRS wireless connection point.

The human-machine operating platform 4 includes the following types: Google cell phone with the Android system and the cell phones with IOS system, such as iPhones and IPADs supporting Chinese and English.

The interface function of the human-machine operating platform 4 can be seen in the table below:

| Item | Title of the page | Functions |
|---|---|---|
| 1 | Socket | Initialization management of the socket, such |
| | management | as setting, naming and classification |
| 2 | Socket inquiry | Online inquiry of the current, voltage, power |
| | | and switching state |
| 3 | Socket control | Timing control over each socket switch |
| 4 | Selection of the | Control via WIFI local network or GPRS in |
| | control mode | which the later realizes remote control over |
| | | selection via WIFI. |

In this utility model, the control system is integrated and modularized, including an intelligent socket with a USB communication function; a ZigBee-USB conversion module; a ZigBee and WIFI, GPRS communication protocol conversion module; a user terminal operation interface, supporting WIFI and GPRS communication.

By combining the perspective features of ZigBee and WIFI and by establishing a local network with the ZigBee technology (802.15.4), the WIFI (802.11x) technology and the GPRS technology allow a cell phone to realize remote linking; the system has three kinds of control modes: 1, the cell phone realizes control via the WIFI AD-HOC local network; 2, the cell phone realizes remote control in the WIFI+AP mode via the internet; 3, the cell phone realizes remote control via GPRS, wherein the user terminal platform includes the Android system, two types of IOS cell phone platforms and the IPAD control platform.

The above preferable embodiment is the detailed description of the utility model, which cannot be regarded as the limitation of the utility model. For those skilled in this field, any simple modification or optimization made within the concept of the utility model shall belong to the protective scope of the utility model.

What is claimed is:

1. An intelligent control socket system, comprising a socket function module set (1) and also comprising a ZigBee module set (2), a local network control host (3) and a human-machine operating platform (4) which is connected with the socket function module set (1) in turn, wherein the socket function module set (1) is in connection and communication with the ZigBee module set (2) by USB; the ZigBee module set (2) is in wireless connection and communication with the local network control host (3) via ZigBee; and the local network control host (3) is in connection and communication with the human-machine operating platform (4) via WIFI and GPRS.

2. The intelligent control socket system according to claim 1, characterized in that the socket function module set (1) comprises a liquid crystal display module, a protection and power interruption module and an external communication port.

3. The intelligent control socket system according to claim 2, characterized in that the liquid crystal display module comprises a load current display module, a power supply voltage display module, a consumption power display module and a total power consumption display module.

4. The intelligent control socket system according to claim 3, characterized in that the protection and power interruption module comprises an over-current protection module, an over-voltage protection module and a high-temperature protection module.

5. The intelligent control socket system according to claim 4, characterized in that the external communication port comprises a USB communication interface in connection and communication with an external load control device and a USB communication interface in connection and communication with the ZigBee module set (2).

6. The intelligent control socket system according to claim 5, characterized in that the ZigBee module set (2) is externally provided with a USB communication connector so as to be in uplink connection with the local network control host (3) and in downlink connection with the socket function module set (1).

7. The intelligent control socket system according to claim 6, characterized in that the ZigBee module set (2) is in wireless connection and communication with the local network control host (3) via the ZigBee; the ZigBee is the 802.15.4 protocol.

8. The intelligent control socket system according to claim 7, characterized in that the local network control host (3) is provided with a ZigBee and WIFI communication protocol conversion device, a ZigBee and GPRS communication protocol conversion device, and a liquid crystal display local network operating platform; and the local network control host (3) is also provided with a serial port communication port, and WIFI wireless connection point and a GPRS wireless connection point.

9. The intelligent control socket system according to claim 8, characterized in that the human-machine operating platform (4) comprises an android system, an IOS system and an IPAD control platform.
